(19) United States
(12) Patent Application Publication
(10) Pub. No.: US 2026/0247055 A1
(43) Pub. Date: Aug. 20, 2026

(54) HANDHELD NETWORKED BLUETOOTH SPEAKER HAVING TRANSLATION FUNCTION

(71) Applicant: Beijing Newman Fenghuang Technology Co., LTD, Beijing (CN)

(72) Inventor: Hongfeng Wang, Beijing (CN)

(73) Assignee: Beijing Newman Fenghuang Technology Co., LTD, Beijing (CN)

(21) Appl. No.: 19/438,583

(22) Filed: Jan. 1, 2026

(30) Foreign Application Priority Data
Feb. 17, 2025 (CN) 202520241653.2

(51) Int. Cl. H04R 1/02; G06F 1/16; G06F 3/16; G06F 40/58; G10L 17/26; H04R 1/04

(52) U.S. Cl. CPC H04R 1/025; G06F 1/1635; G06F 3/167; G06F 40/58; G10L 17/26; H04R 1/04; H04R 2420/07; H04R 2420/09; H04R 2499/11

(57) ABSTRACT

A handheld networked Bluetooth speaker having a translation function includes a wireless communication module, a voice button, a sound pickup module, a control module, a voice recognition module, an audio playback module, a loudspeaker, and a battery. When translation is required, the voice button may be pressed, and the sound pickup module captures voice information of a user and converts the voice information into an electrical signal. After the voice recognition module analyzes and recognizes the electrical signal, the control module is connected to a wireless local area network through the wireless communication module for cloud-based translation. Translation results are played under cooperation of the audio playback module and the loudspeaker. The speaker is very convenient to use, and meets diverse needs of users.

### TECHNICAL FIELD

The present disclosure relates to the technical field of Bluetooth speakers, and in particular to a handheld networked Bluetooth speaker having a translation function.

### BACKGROUND

A handheld Bluetooth speaker refers to a compact audio playback device, such as a mini Bluetooth speaker. In scenarios such as outdoor walks or outings, the handheld Bluetooth speaker is commonly held by a user or hung on a backpack for operation, with high convenience.

However, portable Bluetooth speakers in the prior art have relatively single functions, and the portable Bluetooth speakers only provide audio playback without additional functions, failing to satisfy the diverse needs of users.

### SUMMARY

An objective of the present disclosure is to provide a handheld networked Bluetooth speaker having a translation function, so as to solve the problem of relatively single functions of portable Bluetooth speakers mentioned in the background.

To achieve the above objective, the present disclosure provides the technical solutions as follows:

A handheld networked Bluetooth speaker having a translation function includes a wireless communication module, a voice button, a sound pickup module, a control module, a voice recognition module, an audio playback module, a loudspeaker, and a battery, where the sound pickup module is connected to the voice recognition module, the wireless communication module, the voice button, the voice recognition module, the audio playback module, and the battery are all connected to the control module, the wireless communication module is configured to be connected to a local area network to perform interactive transmission of data, signal output ends of the voice button and the voice recognition module are connected to a signal input end of the control module, respectively, a signal output end of the control module is connected to a signal input end of the audio playback module, a signal output end of the audio playback module is connected to a signal input end of the loudspeaker, and the battery supplies power to the wireless communication module, the sound pickup module, the voice recognition module, and the audio playback module, respectively through the control module.

In an embodiment, the handheld networked Bluetooth speaker having a translation function further includes a Bluetooth low energy (BLE) module, and the BLE module is connected to the control module.

In an embodiment, the handheld networked Bluetooth speaker having a translation function further includes an input charging female socket, the input charging female socket is electrically connected to the battery through the control module, and the input charging female socket is configured to charge the battery.

In an embodiment, the input charging female socket is configured as a TYPE-C charging female socket and/or a MICRO USB charging female socket.

In an embodiment, the handheld networked Bluetooth speaker having a translation function further includes a storage module, where the storage module is connected to the control module, and the storage module is configured to store translation information.

In an embodiment, the handheld networked Bluetooth speaker having a translation function further includes a display module, where an output end of the control module is connected to an input end of the display module, and the display module is configured to display translation information.

In an embodiment, the wireless communication module is configured as a WIFI module, a 4G communication module, or a 5G communication module.

In an embodiment, the handheld networked Bluetooth speaker having a translation function further includes a plurality of Push-to-Talk (PTT) buttons and a plurality of shortcut buttons, and the plurality of PTT buttons and the plurality of shortcut buttons are all connected to the control module.

Compared with the prior art, the present disclosure has the beneficial effects as follows:

According to the handheld networked Bluetooth speaker having a translation function, by means of the cooperative arrangement of the wireless communication module, the voice button, the sound pickup module, the control module, the voice recognition module, the audio playback module, the loudspeaker, and the battery, when translation is required, the voice button may be pressed, and the sound pickup module captures voice information of a user and converts the voice information into an electrical signal. After the voice recognition module analyzes and recognizes the electrical signal, the control module is connected to the wireless local area network through the wireless communication module for cloud-based translation. Translation results are played under cooperation of the audio playback module and the loudspeaker, such that use is quite convenient, and diverse needs of users may be met.

By means of the arrangement of the BLE module, the BLE module is connected to a cellphone terminal of the user, the control module controls the sound pickup module to capture voice information of the user. The control module compresses the voice information captured by the sound pickup module, and the compressed voice information is sent to a cellphone APP via the BLE module. After the cellphone APP receives the voice information, the voice information is locally or synchronously sent to a cloud server for translation. Translation results are directly received or forwarded by the cellphone APP and are subjected to data compression, and then the compressed translation information is sent to a Bluetooth speaker body under cooperation of the Bluetooth of the cellphone and the BLE module. After being decoded by the audio playback module under control of the control module, the translation information is played through the loudspeaker. Therefore, the use is very convenient, and there is no need to open cellphone translation software by the user, thereby achieving a more convenient and faster effect, and enriching the functions of the portable Bluetooth speaker.

### BRIEF DESCRIPTION OF THE DRAWINGS

FIG. 1 is a schematic structural view of a handheld networked Bluetooth speaker having a translation function in Embodiment 1 of the present disclosure.

FIG. 2 is a schematic structural view of a handheld networked Bluetooth speaker having a translation function in Embodiment 2 of the present disclosure.

### DETAILED DESCRIPTIONS OF THE EMBODIMENTS

To enable the objectives, features, and advantages mentioned above of the present disclosure to be more apparent and easily understood, particular implementations of the present disclosure will be described in detail below in combination with the accompanying drawings. Many specific details are set forth in the following description to facilitate full understanding of the present disclosure. However, the present disclosure may be implemented in many other ways different from those described herein, similar improvements may be made by those skilled in the art without departing from the connotation of the present disclosure, and therefore the present disclosure is not limited by the particular embodiments disclosed below.

It should be noted that when an element is considered to be “connected” to another element, the element may be directly connected to another element or there may be an intermediate element simultaneously. On the contrary, when the element is referred to as being “directly” connected to another element, there is no intermediate element.

Unless otherwise defined, all technical and scientific terms used herein have the same meaning as commonly understood by those skilled in the technical field of the present disclosure. The terms used in the description of the present disclosure herein are just for the purpose of describing specific implementations, and are not intended to limit the present disclosure. The term “and/or” used herein includes any and all combinations of one or more related items listed.

### Embodiment 1

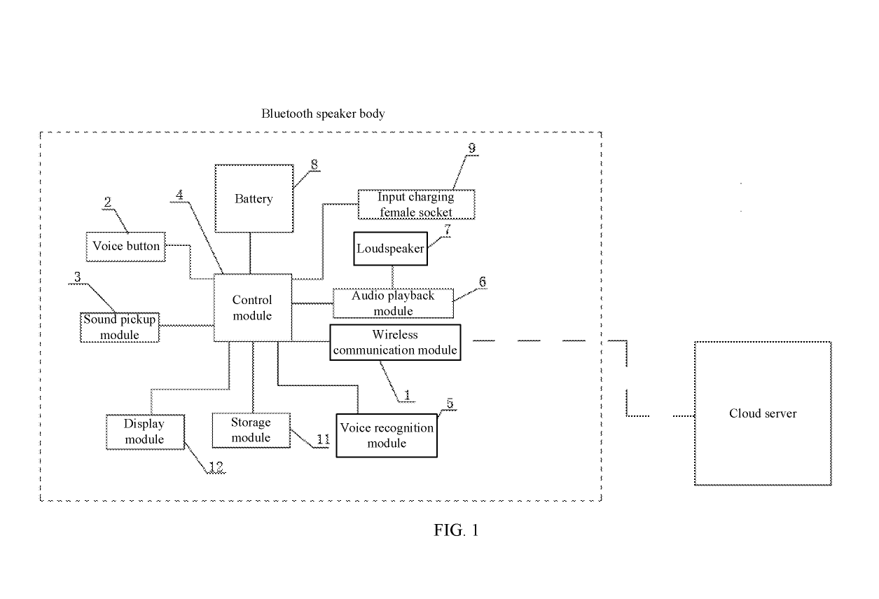

With reference to FIG. 1, a handheld networked Bluetooth speaker having a translation function, including a wireless communication module 1, a voice button 2, a sound pickup module 3, a control module 4, a voice recognition module 5, an audio playback module 6, a loudspeaker 7, and a battery 8, where the sound pickup module 3 is connected to the voice recognition module 5, the wireless communication module 1, the voice button 2, the voice recognition module 5, the audio playback module 6, and the battery 8 are all connected to the control module 4, the wireless communication module 1 is configured to be connected to a local area network to perform interactive transmission of data, signal output ends of the voice button 2 and the voice recognition module 5 are connected to a signal input end of the control module 4, respectively, a signal output end of the control module 4 is connected to a signal input end of the audio playback module 6, a signal output end of the audio playback module 6 is connected to a signal input end of the loudspeaker 7, and the battery 8 supplies power to the wireless communication module 1, the sound pickup module 3, the voice recognition module 5, and the audio playback module 6, respectively through the control module 4.

The wireless communication module 1 is configured as a WIFI module, a 4G communication module, or a 5G communication module, which has the ability to be connected to a wireless local area network, and the sound pickup module 3 is specifically a microphone.

When a user needs to perform a translation operation, the user only needs to press and hold the voice button 2. The control module 4 controls the sound pickup module 3 to collect voice information of the user, and the voice information is analyzed and recognized by the voice recognition module 5 and converted into corresponding network search instructions. The control module 4 controls the wireless communication module 1 to send the network search instructions to a cloud for translation. After translation results are received via the wireless communication module 1, the control module 4 controls the audio playback module 6 to decode the translation results and broadcast the same through the loudspeaker 7. The default translation in the present disclosure is from Chinese to English.

In this way, by means of the cooperative arrangement of the wireless communication module 1, the voice button 2, the sound pickup module 3, the control module 4, the voice recognition module 5, the audio playback module 6, the loudspeaker 7, and the battery 8, when translation is required, the voice button 2 may be pressed, and the sound pickup module 3 captures the voice information of the user and converts the voice information into an electrical signal. After the voice recognition module 5 analyzes and recognizes the electrical signal, the control module 4 is connected to the wireless local area network through the wireless communication module 1 for cloud-based translation. Translation results are played under cooperation of the audio playback module 6 and the loudspeaker 7, such that use is quite convenient, and diverse needs of users may be met.

### Example 2

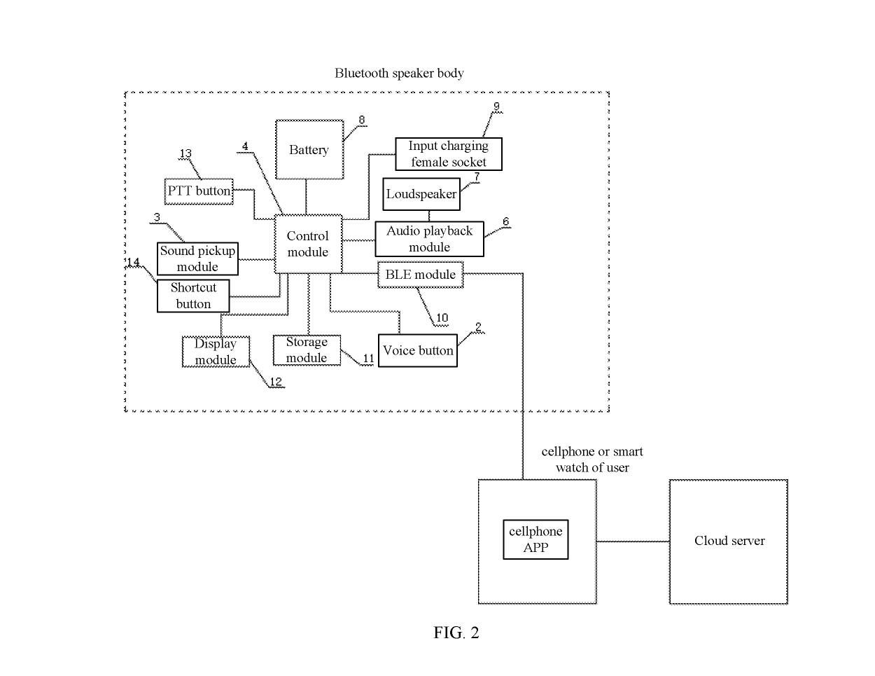

With reference to FIG. 2, a handheld networked Bluetooth speaker having a translation function, including a Bluetooth low energy (BLE) module 10, a voice button 2, a sound pickup module 3, a control module 4, an audio playback module 6, a loudspeaker 7, and a battery 8, where the BLE module 10, the voice button 2, the sound pickup module 3, the audio playback module 6, and the battery 8 are all connected to the control module 4, the BLE module 10 is configured to perform interactive transmission of data with an external cellphone terminal, signal output ends of the voice button 2 and the sound pickup module 3 are connected to a signal input end of the control module 4, respectively, a signal output end of the control module 4 is connected to an input end of the audio playback module 6, a signal output end of the audio playback module 6 is connected to a signal input end of the loudspeaker 7, and the battery 8 supplies power to the BLE module 10, the sound pickup module 3, and the audio playback module 6, respectively through the control module 4.

The control module 4 may compress data, and the BLE module 10 may perform quick transmission on the compressed data. Generally, the sound pickup module 3 may be a microphone. Furthermore, when a cellphone is only connected to the BLE module 10, original traditional Bluetooth functions are not affected, such as not interfering with the original call and music playback functions. Moreover, power consumption may be effectively reduced when a continuous connection is maintained, thereby achieving greater practical significance.

When a translation function is required, the voice button 2 is pressed, and the control module 4 controls the BLE module 10 to establish a Bluetooth connection to the cellphone. Meanwhile, the control module 4 controls the sound pickup module 3 to capture voice information of a user, and the voice information is sent to a cellphone APP through the BLE module 10. After the cellphone APP receives the voice information, the voice information is synchronously sent to a cloud server for translation. Translation results are received by the cellphone APP from the cloud server, and sent to the BLE module 10 after being subjected to data compression. The compressed translation information is sent to a Bluetooth speaker body through the Bluetooth of the cellphone. After being decoded by audio playback module 6 under control of the control module 4, the translation information is played through the loudspeaker 7. The default translation in the present disclosure is from Chinese to English. In this embodiment, the cellphone APP is Weifeng APP having an intercom function.

In this way, according to the handheld networked Bluetooth speaker having a translation function, by means of the cooperative arrangement of the BLE module 10, the voice button 2, the sound pickup module 3, the control module 4, the audio playback module 6, the loudspeaker 7, and the battery 8, when translation is required, the voice button 2 may be pressed, the control module 4 controls the sound pickup module 3 to capture the voice information of the user, the control module 4 compresses the voice information captured by the sound pickup module 3, and the compressed voice information is sent to the cellphone APP via the BLE module 10. After the cellphone APP receives the voice information, the voice information is synchronously sent to the cloud server for translation. Translation results are received by the cellphone APP and are subjected to data compression, and the compressed translation information is sent to a portable Bluetooth speaker body under cooperation of the Bluetooth of the cellphone and the BLE module 10. After being decoded by the audio playback module 6 under control of the control module 4, the translation information is played through the speaker 7. Therefore, the use is very convenient, and there is no need to open cellphone translation software by the user, thereby achieving a more convenient and faster effect, enriching the functions of the portable Bluetooth speaker, and meeting diverse needs of users.

In an embodiment, the handheld networked Bluetooth speaker having a translation function further includes an input charging female socket 9, and the input charging female socket 9 is electrically connected to the battery 8 through the control module 4, and is configured to charge the battery 8. The input charging female socket 9 is configured as a TYPE-C charging female socket and/or a MICRO USB charging female socket.

Thus, the battery 8 of the Bluetooth speaker body may be charged by connecting an external adapter to the input charging female socket 9.

In an embodiment, the handheld networked Bluetooth speaker having a translation function further includes a storage module 11, where the storage module 11 is connected to the control module 4, and the storage module 11 is configured to store translation information.

Thus, both the voice information of the user captured by the sound pickup module 3 and the corresponding translation information may be stored in a preset location of the storage module 11 for subsequent reference when needed.

In an embodiment, the handheld networked Bluetooth speaker having a translation function further includes a display module 12, and an output end of the control module 4 is connected to an input end of the display module 12, so as to display translation information.

In this way, when the translation information is sent to the control module 4 via the BLE module 10, the control module 4 may display the translated content through the display module 12, and the display module 12 is specifically a display screen, such that the user may also obtain visual information synchronously while listening to the translated audio, thereby acquiring the translated content quickly and accurately, and avoiding the inability to quickly and accurately obtain the translated content caused by only relying on the audio to access the translated content.

Furthermore, the control module 4 is a real-time operating system (RTOS)-based embedded computing and processing platform and is specifically a processor having a voice intercom function, or a computing platform capable of running intercom processes and data processing programs, and may also be an embedded computing and processing platform.

In an embodiment, the handheld networked Bluetooth speaker having a translation function further includes a plurality of Push-to-Talk (PTT) buttons 13 and a plurality of shortcut buttons 14, the plurality of PTT buttons 13 and the plurality of shortcut buttons 14 are all connected to the control module 4, and both the plurality of PTT buttons 13 and the plurality of shortcut buttons 14 are configured for quick intercom calling and answering.

When the user needs to initiate a voice intercom, the user may use the PTT button 13 to control a speaker main body of the present disclosure to enter the working mode for the real-time intercom. Additionally, the shortcut button 14 may be preset to a specific contact in advance, and then the user may use the shortcut button 14 to contact the specific contact, which is used for quick calling and answering.

What are described above are merely preferred particular implementations of the present disclosure, but the protection scope of the present disclosure is not limited thereto. Equivalent substitutions or changes that are made by any of those skilled in the art and familiar with the technical field within the technical scope disclosed by the present disclosure on the basis of the technical solutions and concepts of the present disclosure should be covered within the protection scope of the present disclosure.

1. A handheld networked Bluetooth speaker having a translation function, comprising a wireless communication module, a voice button, a sound pickup module, a control module, a voice recognition module, an audio playback module, a loudspeaker, and a battery, wherein the sound pickup module is connected to the voice recognition module, the wireless communication module, the voice button, the voice recognition module, the audio playback module, and the battery are all connected to the control module, the wireless communication module is configured to be connected to a local area network to perform interactive transmission of data, signal output ends of the voice button and the voice recognition module are connected to a signal input end of the control module, respectively, a signal output end of the control module is connected to a signal input end of the audio playback module, a signal output end of the audio playback module is connected to a signal input end of the loudspeaker, and the battery supplies power to the wireless communication module, the sound pickup module, the voice recognition module, and the audio playback module, respectively through the control module.

2. The handheld networked Bluetooth speaker having a translation function according to claim 1, further comprising a Bluetooth low energy (BLE) module, and the BLE module is connected to the control module.

3. The handheld networked Bluetooth speaker having a translation function according to claim 1, further comprising an input charging female socket, wherein the input charging female socket is electrically connected to the battery through the control module, and the input charging female socket is configured to charge the battery.

4. The handheld networked Bluetooth speaker having a translation function according to claim 3, wherein the input charging female socket is configured as a TYPE-C charging female socket and/or a MICRO USB charging female socket.

5. The handheld networked Bluetooth speaker having a translation function according to claim 1, further comprising a storage module, wherein the storage module is connected to the control module, and the storage module is configured to store translation information.

6. The handheld networked Bluetooth speaker having a translation function according to claim 1, further comprising a display module, wherein an output end of the control module is connected to an input end of the display module, and the display module is configured to display translation information.

7. The handheld networked Bluetooth speaker having a translation function according to claim 1, wherein the wireless communication module is configured as a WIFI module, a 4G communication module, or a 5G communication module.

8. The handheld networked Bluetooth speaker having a translation function according to claim 1, further comprising a plurality of Push-to-Talk (PTT) buttons and a plurality of shortcut buttons, wherein the plurality of PTT buttons and the plurality of shortcut buttons are all connected to the control module.
